(19) United States
(12) Patent Application Publication
(10) Pub. No.: US 2009/0182745 A1
(43) Pub. Date: Jul. 16, 2009

(54) Methods and Apparatus for Creating, Managing, and Displaying Content Channel and Weblog Dialogues

(76) Inventor: Mark Mallen Huck, Seattle, WA (US)

Correspondence Address: MARK M. HUCK, 912 2ND AVE. W., SEATTLE, WA, 98119, US

(21) Appl. No.: 12/350,925

(22) Filed: Jan. 8, 2009

Related U.S. Application Data
(60) Provisional application No. 61/020,317, filed on Jan. 10, 2008.

(51) Int. Cl. G06F 7/06; G06F 3/00; G06F 17/30

(52) U.S. Cl. 707/7; 715/751; 707/104.1; 707/E17.014

(57) ABSTRACT

Systems and methods for creating, managing, and displaying online content channel dialogue—particularly weblog debates—are provided. Online content channels do not presently show ways for users to pull content together and publish comments out to the content for the purpose of developing a robust debate or dialogue. The present invention enables the end-user to randomly select multiple content channels and initiate such dialogue between them. End-user comments may be simultaneously published to all content channels, and such comments may have logical metadata attached to allow the end-user to pull together all content within a debate into a logical framework.

### BACKGROUND OF THE INVENTION

1. Field of the Invention

This invention relates to Class 706 (DATA PROCESSING: ARTIFICIAL INTELLIGENCE), 45 (KNOWLEDGE PROCESSING SYSTEM), 59 (CREATION OR MODIFICATION), 60 (EXPERT SYSTEM OR SHELL).

2. Description

Weblogs, also known as blogs, allow content writers to easily publish content onto the Internet. People reading these weblogs can write comments about them and submit them. The writers, then, can either automatically or manually approve the comments for other readers to view. Many weblogs give writers the option of also having a Really Simple Syndication (RSS) feed available so that readers to allow the content to become syndicated; that is, used on other sites freely or for a fee. RSS utilizes a variant of Extensible Mark-up Language (XML) called Resource Description Framework (RDF). The XML and RDF standards are owned by the World Wide Web Consortium (w3c). By adhering to these standards, sites programmatically consuming these feeds can do so easily and efficiently.

Many sites offer weblog capabilities to writers. For example, Blogger.com allows writers to quickly set up a weblog page on the internet. Blogger.com was acquired by Google around 2003, and uses a variant of RDF called Atom for its feeds. Weblog writers, often referred to as “bloggers”, use weblogs for many reasons. Chief among these are to express political or social views on a variety of subjects, from the national economy to local school systems. Multiple users may contribute to a single weblog, and this collaboration is easily accomplished using current weblog systems on the Internet.

These weblogs, however, are stand-alone publications. While the individual weblogs can be aggregated by reader applications known as aggregators, the weblogs themselves cannot interact with one another. For example, a comment left on one weblog is not written to other weblogs discussing similar subjects. A further weakness is that readers have a difficult time following “battles” between weblogs, where discussions are taking place in two or more locations on the internet. Reading, let alone tracking, these discussions is time consuming and difficult. Together, the weaknesses are referred to as “interaction barriers”.

These interaction barriers exist between all content channels on the internet. Content owners are adverse to debate, though many channels provide a minimal capability allowing users to comment on content. While users can subscribe to feeds, the feeds themselves are not organized in relation to each other for the purpose of debate or dialogue. Yet, the development of grounded knowledge is most often accompanied by robust debate. Entities espousing a viewpoint are not held to a high standard where debate on that viewpoint is not readily and easily apparent to the audience. In sciences, for example, the ability of an experiment to be replicated is critical to the validity of the experiment's conclusions. In historical analysis, subjecting facts and interpretations to a variety of viewpoints helps to refine the analysis and drive out bias and error. Interaction barriers must be minimized in order to maximize

Therefore, in order to elevate the discussions on individual content channels, such as weblogs, a system is needed to reverse the isolated nature of the streams and overcome interaction barriers.

### SUMMARY OF THE INVENTION

The present invention solves the interaction barriers of these independent content channels, such as weblogs, in several ways. First, a debate or dialogue is established between two or more distinct content channels. This may be accomplished in several ways, but a typical way is to maintain a website where anyone may identify two or more weblogs—each having a RSS feed or other API available—to include in a debate, and may include other information such as the category of the issue being debated, the contact information of the bloggers, and so forth. With an issue, such as “impact of human activity on global warming”, and category, such as “environment”, identified, the end-user then indicates the position of the weblogs relative to the issue. For example, a specific weblog may be “pro”, “con”, “alternative”, or “undecided”.

Typically, the content channel owner would need to provide access rights to add comments to the owner's content. Therefore, the present invention shows that the owner would be contacted when owner's content was included in a debate in order that the owner could enable access to owner's comment facility.

A second way the present invention overcomes the interaction barrier is to allow readers to add comments simultaneously onto two or more independent content channels. In this way, each contributing content channel has the benefit of receiving the same comment. Moreover, the reader does not need to make multiple entries of the comment.

Third, the present invention extends content channels into the realm of logic-based knowledge creation by providing readers a method to specify the logical (or analytical) relationship of what they are adding. For example, the reader might indicate that her comment is a “fact”, or an “analysis”, and/or a “deduction”. Additional metadata can also indicate whether the comment supports the specific content channel's argument. Given this metadata, the present invention discloses methods whereby the debate may be organized such that a document or may be published based on these logical relationships.

Finally, the present invention is able to show the relative scores of the content channels in the debate or dialogue. This scoring may be computed based on a variety of algorithms. A simple example would be to display the sum of comments in support of a content channel less that sum of comments weakening that channel's argument. More complex scoring could take into consideration the reputation of the reader, rebuttals to a particular comment, and other factors.

This new capability would enable scenarios such as politicians representing two positions on a topic opening a debate between supporters of one or the other position. The debate positions of the two camps would establish the initial content for the debate. Then, readers could add comments—such as facts, considerations, or deductions—that would create logical support for each of the positions. Overlaps and inconsistencies might become more apparent through such open exchange. Then, when another user wished to review the debate, they could create a document displaying the facts, arguments, assumptions, and conclusions of each side in the debate and make decisions based on that information.

A further application of the present invention is in the academic realm. A teacher could assign a specific issue, and ask groups of students to establish content channels that would argue and defend a particular position on that issue. The groups could be graded on their ability to increase their scores. Rogue, inappropriate, or comments could be considered by an arbitrator of the issue who would be enabled to increase or decrease weighting, or delete comments as required. This arbitrator could be the teacher.

The combination of weblogs does not necessarily needed to be adversarial. The weblogs could be combined in a collaborative format, again allowing each to exist independently while giving readers a way to participating in and judge both simultaneously. In a collaborative work environment, this capability would encourage alternative viewpoints on an issue facing a work team while helping to discern the weight of the competing views.

The collaborative approach would also allow for a number of alternatives to be assessed. A particular comment might lend weight to some of the alternatives while weakening others. The arbitrator could be either a single individual or a team. Within a controlled environment such as a team, the reputation of contributed comments could inform the weighting algorithm.

Independent debates on the same topic could subsequently be combined to provide a more extensive view of a particular issue.

Hitherto, no art has shown this capability of distinct published content being combined or arranged into a debate format where readers or observers may comment simultaneously on all content. Moreover, the capability of specifying the logic type of the added comments to enable the construction of a reasoned argument has not been shown in prior art. Online debate forums exist, such as at onlinedebate.net, as do numerous forums. However, these applications require content owners to input content into the application rather than having the content owners (or others) subscribe their content streams to a system, thereby allowing users to continue visiting and using the original content source.

U.S. Pat. No. 6,980,983 (2005) to Banerjee describes a method for collaborative decision-making. However, this art shows a single system of content and not a system allowing various content channels to subscribe or be subscribed to it for the purposes of decision-making.

Patent application #20080281832 to Pulver describes aggregation of content via RSS. However, it does not show methods for creating a debate-type format between existing blogs.

While patent application Ser. No. 11/724,632 to Huck shows such logic being specified as a result of a search result, that art does not show such determination in relation to an ongoing dialogue involving multiple content sources on the Internet.

### OBJECTS AND ADVANTAGES

A principle advantage of the present invention is to enable the engagement of independent published sources online, typically weblogs, in a debate format. By doing so, and by enabling additional logic attributes to be specified by readers adding comments to the debate, a new and surprising dialogue mechanism is enabled in a network environment.

Accordingly, the objects and advantages of the present invention are to:
(a) provide a method and apparatus which allows content—such as blogs—readers to specify two or more content channels to engage in a dialogue or debate in such a way that subsequent comments by readers may be added to any or all of the content channels together with logic metadata.
(b) provide a method and apparatus for putting the content channel content through a logical taxonomy such that the reader may view a particular discussion or debate in a essay-type format, where the thesis may, for example, be followed by assumptions, facts, analysis, reasoning, and conclusions.
(c) provide a method and apparatus by which the content channels can be scored relative to each other on the basis of the weight of the original content as well as associated comments from readers

Further objects and advantages are to provide a mechanism whereby the content channel owners receive compensation for their contributions to a debate if advertising or other revenue is created by virtue of readers viewing the debate. Still further objects and advantages will become apparent from a consideration of the ensuing description and drawings.

### BRIEF DESCRIPTION OF THE DRAWINGS

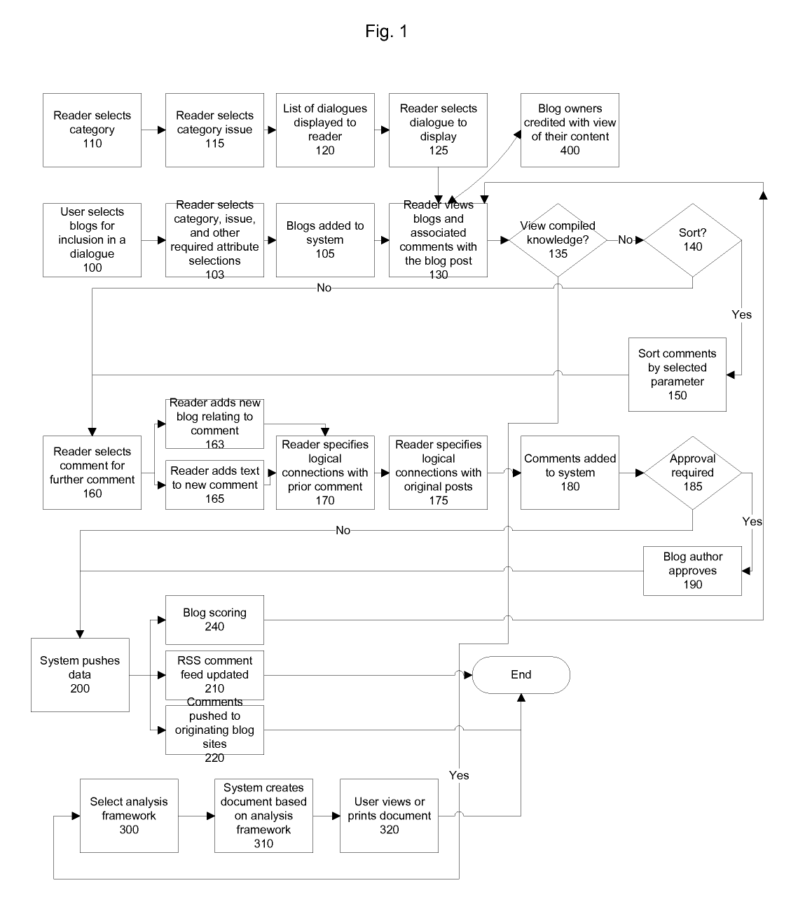

A typical embodiment of this invention is shown in drawing FIG. 1. The figure should not be considered to limit the scope of the invention, and is shown to represent a typical embodiment of the invention claims.

### DETAILED DESCRIPTION OF THE PREFERRED EMBODIMENTS

Description of FIG. 1

Any operator may start a blog dialogue by selecting least 2 blogs (100), a category, and any other system attribute required (103) as descriptors of the dialogue. Operator submits the dialogue and system adds it into its datastore (109). Alternately, operator (reader) may view a list of existing dialogues (120) by selecting a category (110), then an issue if desired (115), and then selects a displayed dialogue to view (125).

The operator may then either view the dialogue in various analytical views (135) or choose to sort the comments according to the attributes of the comments (150). If the first is chosen, the operator selects a analysis framework (300) representing a taxonomy for displaying the dialogue. The system then selects the various comment content based on this taxonomy (310) and presents it to the operator or prints it (320).

If the second option (15) is chosen, the operator then may elect to sort the comments on the viewed dialogue according to any of several attributes (150) in order to understand the dialogue better. The operator may then select any of the comments or the original post itself (160) and add operator's own comments into the dialogue (165) together with attributes that define the logical relationship of operator's new comment to the selected comment (170) as well as to the original posts (175). The system adds the comments into the system (180). If approval is required (185), the blog author or other system-approved operator approves the comment (190).

The system then re-publishes the comments RSS (210) and, if an API is available, updates the original post comments on their respective original systems (220).

Based on the logical relationships and other metadata associated with the comments and the original post, the system scores each blog (240) and this score is presented to the user when the user views the dialogue or debate (140).

Whenever readers view a dialogue, the content owners may be credited with the view (400) in order to apportion advertising or other revenue created by such view.

### CONCLUSIONS, RAMIFICATIONS, AND SCOPE

Accordingly, the reader will see that this invention provides highly functional methods for providing the operator a means for joining various viewpoints of a particular topic, commenting on each with a single comment, organizing the resulting commentary and, finally, understanding the strengths and weaknesses of the viewpoints via numeric or other indicators.

Although the description above contains many specificities, these should not be construed as limiting the scope of the invention but as merely providing illustrations of some of the presently preferred embodiments of this invention.

Thus, the scope of the invention should be determined by the appended claims and their legal equivalents, rather than by the examples given.

### REFERENCES

U.S. Pat. No. #6,980,983 (December, 2005) “Method for collective decision-making” to Banerjee
patent application Ser. No. 11/724,632 (March, 2006) “Methods and Apparatus for Content Search Using Logical Relationship Taxonomies” to Huck.
Patent Application #20080281832 (November, 2008) “System and Method for Processing RSS Feeds” to Pulver

What is claimed is:

1. A method for combining, annotating, storing, and displaying multiple content channels simultaneously whereby said method allows operator to select two or more content channels representing various viewpoints on a particular topic and combining said selected channels such that the contents of each said channel are visible simultaneously and to a plurality of operators based on said topic, and owners of said content channels are notified that their respective content has been selected and presented in such format.

2. The method of claim 1 such that each comment made by any operator may be added to any or all of the content channels simultaneously.

3. The method of claim 2 wherein said owners of the content channels may accept or reject such any such comment.

4. The method of claim 2 wherein the user adding comment or the system also attributes the comment according to its logical or other relationship to the original content channel content.

5. The method of claim 4 wherein the relationships are weighted and such weightings are aggregated and a summary displayed to the end-user.

6. The method of claim 4 wherein the comments are grouped by the relationship attribute.

7. The method of claim 5 wherein the weightings are derived from other operators' specifying weights based on a system wherein operators' are identified as experts in relation to the dialogue.

8. The method of claim 6 wherein all or operator-selected parts of the dialogue are added to operator's own data store or printed.

9. The method of claim 1 wherein said combined content channels relating to a particular topic are combined with other combinations of content channels relating to the same topic.

10. A computer readable medium having stored thereon a plurality of computer-executable instructions for performing the method of claim 1.

11. A computing device comprising means for performing the method of claim 1.

12. A computer readable medium in a networked computer system, at least one computing device on network having components
a. providing a memory which is able to store incoming information received over a network into said memory,
b. providing a persistent data storage which is able to store incoming information received from said memory,
c. providing a processor,
d. providing such network devices necessary to connect to a network of computers,
e. providing a display which is operatively connected to such memory,
f. providing a character input means which a human operator can use to enter information into said browser
and having a plurality of computer-executable modules for storing, reading, and displaying multiple content channels whereby said modules operator to select two or more content channels representing various viewpoints on a particular topic and combining said selected channels such that the contents of each said channel are visible simultaneously and to a plurality of operators based on said topic, and owners of said content channels are notified that their respective content has been selected and presented in such format.

13. A computer readable medium of claim 12 such that comments may be added to any or all of the content channels simultaneously.

14. A computer readable medium of claim 13 wherein the original authors of the content channels may accept or reject such any such comment.

15. A computer readable medium of claim 14 wherein the user adding comment or the system also attributes the comment according to its logical or other relationship to the original content channel content.

16. A computer readable medium of claim 15 wherein the relationships are weighted and such weightings are aggregated and a summary displayed to the end-user.

17. A computer readable medium of claim 15 wherein the comments are grouped by the relationship attribute.

18. A computer readable medium of claim 15 wherein the weightings are derived from other operators' specifying weights based on a system wherein operators' are identified as experts in relation to the dialogue.

19. A computer readable medium of claim 17 wherein all or operator-selected parts of the dialogue are added to operator's own data store or printed.

20. The method of claim 12 wherein said combined content channels relating to a particular topic are combined with other combinations of content channels relating to the same topic.
